(19) United States
(12) Patent Application Publication
(10) Pub. No.: US 2003/0233982 A1
(43) Pub. Date: Dec. 25, 2003

(54) Raising fly larvae as the space food for crew

(76) Inventor: Mao Zhang, Fontana, CA (US)

Correspondence Address: Mao Zhang, 5578 SPUR CT, Fontana, CA, 92336, US

(21) Appl. No.: 10/178,344

(22) Filed: Jun. 25, 2002

(51) Int. Cl. A01K 29/00

(52) U.S. Cl. 119/6.5

(57) ABSTRACT

To raise fly larvae (FL) as space food besides crop plants for waste recycling and food production. NASA has been cultivating crop plants as the space food. The feedstuff nutrition from both crew's waste (faces and urine) and crop's waste can be recycled by FL to achieve the goal of efficiently producing nourishing food. The water and nutrition leaving in the dreg after raising HFL can be recycled and fertilized the crop plant again. Raising HFL combining with crop plants could develop a self circular closed system from most wastes to enable human to live and work in space-independent of earth-provided logistics in long duration mission.

### REFERENCE CITED

U.S. PATENT DOCUMENTS U.S. Pat. No.: 5,618,574 April 1997 Bunch 426/641 Only one related U.S. patent-titled “Fish Food” was founded in searching of U.S. patent from January 1974 to November 2001. This patent apply dried fly larvae as fish food to improve the growth, feeding efficiency or coloration of fish.

### OTHER PUBLICATIONS

(1) NASA, “JSC Advanced Life Support.”

http://adv life support, jsc. nasa.gov/display.HTML

(2) Rei wen: International Space, August 2001, 6-8,

“Space Life Support System for Astronauts in 21 Century”.

(3) Li Guang Hong, et al, Entomological Knowledge, 2000, (37): 318-320

“Cryopreservation of insect embryos in liquid Nitrogen.”

(4) Lynch D. V., et al. Cryobiol., 1989, (26): 445-452

“A Two-Step Method for Permeabilization of Drosophila Eggs.”

(5) Mazur P., et al. Cryobiol., 1993, (30): 45-73

“Contributions of cooling and warming rate and developmental stage to the survival of Drosophila embryos cooled to −205° C.”

(6) Wang Darui et al, Entomological Knowledge 1991 (4): 247-249

“Analysis and utilizing of the Nutritional Contains of Housefly Larvae.”

(7) Zhang Zhe sheng, et al, Science and Technology of Food Industry 1997 (6): 67-69

“Exploration House Fly Larvae as a Potential Food Protein Resource for Human.”

(8) Li Guanghong, et al, Entomological Knowledge, 1997 34 (6): 347-349

“Nutritional evaluation of extracted Housefly Protein.”

(9) Lei ChaoLiang, et al, Journal of Huazhong Agriculture University 1998 17 (2): 138-142

“Evaluating of the Health Function of Fly-Maggot Nourishing Active Powder.”

(10) Zhang Tingjun, Helongjiang Education Press. 1999.11. Beijing,

“Exploitation of Housefly Larvae.” Animal Research Institute, China Science Academy.

(11) Ren Guodong, et al, Entomological Knowledge, 2002 39(2): 103-106

“Factory Production and its development Future for House Flies.”

(12) Wei Yongping et al, China Agriculture Press. Beijing, August 2001.

“Raising of Economic Insects and Its Exploitation.”

STATEMENT REGARDING FEDERALLY SPONSORED RESEARCH OR DEVELOPMENT

There is no any federally sponsored research or development in this invention.

REFERENCE TO SEQUENCE LISTING, A TABLE OR A COMPUTER PROGRAM LISTING COMPACT DISC APPENDIX

It is not applicable in this case

### BACKGROUND OF THE INVENTION

As to long duration mission in the future, the storage of food and food ingredients are main problems for supporting the crew living and working in the space. Due to the food quantity for sustaining crew is very large, it is impossible to carry the main food by the spaceship before leaving the earth. It should be produced in the space with a self-sufficiency close-loop system. Moreover, so far we have found that crew would be in a state of malnutrition and lose tissue in microgravity. In fact, the nutrition for crew are quite complicated, some are unknown to dietician until now, that may lead to malnutrition. Currently, the space food supply of The National Aeronautics and Space Administration of USA (NASA) mainly focus on the growth of crop plants in space, such as wheat, potato, soybean which contain starch or plant protein, it can also contribute to water purification, air revitalization and even the processing of waste materials.[1], but it can't satisfy some other nutrition needs such as animal protein, fat etc. Besides, crops grow with long cycle and low efficiency production, and can't minimize the volume, mass, energy and labor to satisfy an advanced life support system that NASA required. Some researchers in NASA and relevant institutes has developed the technologies recycling nutrition from human's dejection, but so far no one can know how to transform human dejection to nourishing food directly. Currently the crew take nutrition mainly from crop plants and process dejection as fertilizer or burn dejection to CO₂ for crop plant.[2]

What is more, human body's nutrition intake rate is not high and many of nutrition will get away from our bodies with feces and urine, it is the largest source of losing nutrition, such as, crew will lose a lot of Ca with dejection while they are in microgravity. Among them, some are still mysterious to us. If we do not make up something for that, we will get crew malnutrition. In fact the feces and urine are the most valuable nutrition source for crew in long duration mission. We should not get away the dejection as waste. The best way is we should take all those nutrition (known and unknown) from dejection via effective way to back to crew body, thus a self-circular close system: the consuming of the food—dejection—recycling of the dejection for producing of the food. That will make sure crew has adequate nutrition in long-duration mission, and the food source loading and storing in the spaceship can be mninimized before the spaceship leaves the earth, meanwhile the problem of recycling of dejection could achieve.

This invention can solve the above problems. Namely raising maggot combining with crop plants as space food can meet most nutrition needs for astronaut and recycle most wastes(dejection from astronaut and inedible crop plants).

### BRIEF SUMMARY OF THE INVENTION

On international space station, space-based vehicle and early planetary surface habitats, the crew face some waste and food processing problems. According to present waste and food processing methods, the crew mainly raise crop plants as space food and as a way to recycle water and nutrition from dejection. Here we propose raising housefly larvae (HFL) as space food besides crop plants for waste and food processing in long duration mission.

HFL has great vitality and never get disease. They can be easily raised without much care by mixing of the dejection of the crew and cast-off crop (such as wheat bran, bean dregs and crop stalk/leaf) in very small volume of containers where HFL and feedstuff could close touch in microgravity under controlled constant temperature and humidity. The crop are also cultivated as the space food by NASA. Thus the feedstuff nutrition from both crew's waste (faces and urine) and crop waste can be recycled to achieve the goal of efficiently producing nourishing and tasty food. The water and nutrition leave in the dreg after raising HFL can be recycled and fertilized the crop plant again. For decontaminating the viscera of HFLs before baking them, we feed them with the wheat bran/bean dregs and hunger for some hours, then make the HFL food by baking and grinding HFLs with the crop flour and various food dressing. Generally, this HFL food can offer rich nutrition with good taste to crew.

Besides, as current space food, the crop plant, such as wheat, potato, bean mainly offer most calories and plant protein necessary for human body. They can not offer some other adequate nutrition such as animal protein, fat, some kind of amino acids, vitamin, element, and so on. HFL's body consist of rich protein, 18 kinds of amino acids (thereinto 10 kinds are necessary to human body), fat and many kinds of vitamins, minerals, electrolytes. HFL can greatly improve human immune system and resist radiation and other beneficial functions.

Fly eggs have very strong reproduction and growth ability. Their reproduction and growth cycle are very short, usually get mature 4 days after being hatched, and their weight increase by 250-350 times. For 6 gram fly egg can produce 0.4 kg fresh HFL per day which combine with crop plant, is enough for one astronaut's daily nutrition. It is known as one of the most speedy and efficient way to produce nutritious food so far in the world. The froze HFL eggs in liquid nitrogen have long life (more than several hundred years) and recover their growth and reproduction ability once unfreeze. For 5 astronauts in 10 years mission, around 25 kg fly eggs could be brought from earth at the beginning for food source without delivery again. HFLs should be under controlled instead of letting them to become flies during normal situation. While contingency of losing some fly eggs or HFLs, the left HFLs or eggs could be raised to flies and flies reproduce eggs again in short time. We could put a special net cover outside of the container where HFLs are raised and spread feedstuff (usually it is a kind mud made of 70% smash HFL paste with 30% wheat bran) on the net cover so that the flies could bite the feedstuff in microgravity.

Raising HFL combining with crop plants would be a regenerative integrated system with close loops of food, water, air and resource recovery from most wastes. The operations of raising HFL are all under the restrictions of minimum volume, mass, energy and labor. It is an efficient, reliable and effective system in long duration mission.

### DETAILED DESCRIPTION OF THE INVENTION

The Way of Solving the Problem:

Raising maggot in space can recycle the dejection for producing of the food. Maggot can offers rich protein and other nutrition for human. Fly eggs can be offered with minimum capacity in long duration mission by freeze them in liquid nitrogen. The most waste can be recycled by maggot. Combining with the crop biomass, it can achieve close loop regenerating/recycling food/waste.

Maggot is fly larvae (FL). We apply housefly larvae (HFL) as example in our invention. The scientific name of house fly (HF) is Musca Domestica. We select HFL as a sample in our invention, this is because, HFL has strong reproduction ability and short growth cycle, easy to raise in high density, high efficiency and nourishing without poison, never get disease, equipment and operation are simple. Also, raising HFL is a mature technique. HFL are very easy to raise. Fly has fabulous reproduction speed. A couple of HF can produce around 1000 egg during its reproduction period (12-15 days). Theoretically, 1000 eggs can reproduce 200 billion HFL within four months, with 200 billion HFL can produce more than 600 ton pure protein. The egg usually takes 4 days to become mature HFL and 10 days become fly. It has short and speedy reproduction period with high output. The weight of one HF egg is around 0.08 mg (one gram of HF eggs contains 12000-14000 eggs[19]), its weight will be 20-30 mg, which is 250-350 times after raising for 4 days. It is second for none to produce animal protein so far. Moreover, in room temperatures of 25-28° C. and comparative humidity 60-80%, it can reproduce continuously generation by generation. RFL is a light avoiding insect, so it should be raised in dark container instead of in light for photosynthesis like plants.

Nutrition Content of HFL

The data indicating below is from four national academic institutes in China. [6],[7],[8],[12].

The Analysis Result of HFL's Nutrition

The HFL powder is dried from fresh HFL. Its weight is around ⅓ of fresh HFL. HFL powder contains 54-63% of protein which is more than that of fishmeal powder. The fat accounts for 11-17% with similar composing of plant oil or fish liver oil. Amino acids are well combined with 9 kinds essential amino acids for human. The total amount of essential amino acids crucial to our lives is 2.3 times that of fishmeal, the storage of lysine, methionine and phenylalanine are 2.6, 2.7 and 2.9 times that of fishmeal respectively. Two of the essential amino acids, lysine and tryptophan, are poorly in most plant proteins. The essential amino acids account for 43-47% (E %), is more than the referenced standard (40%) issued by FAO/WHO. Essential amino acids/non-essential (E/N) is 0.70-0.89, which is much more than the referenced standard (60%) issued by FAO/WHO[10].

HFL powder contains rich K, Na, Ca, Mg, P and a lot of trace elements necessary for human such as Zn, Fe, Mn, Cu, B, P, Gr, Co, Al, Si, etc

HFL powder contains sufficient vitamin A, D and B. The content of vitamin D is similar with fish-liver. It especially contains rich B₁ and B₁₂ that are insufficient in the crop. B₁ and B₂are respectively 15 and 1800 times that of milk[11].

TABLE 1
Nutrition contents of HFL powder, HFL protein powder
and fishmeal (%)

| | | | | HFL | |
|---|---|---|---|---|---|
| Content | HFL powder | | | protein powder | Fishmeal |
| Data from Ref. | [12] | [8] | [7] | [8] | [6] |
| Protein | 60.88 | 54.47 | 62.70 | 73.03 | 38.6-61.6 |
| Carbohydrate | | 12.04 | | 0 | 2.80 |
| Fat | 17.1 | 11.60 | 11.20 | 23.10 | 1.2 |
| Gross Fiber | | 5.70 | | 0 | 19.41 |
| Ash Content | 9.2 | 11.43 | 10.42 | 1.83 | 20 |
| Moisture Content | | 5.80 | 5.10 | 3.34 | 11.40-13.50 |
| Chitin | | | 3.97 | | |

HFL protein powder is enriched from HFL powder processed with method of acid deposition.

TABLE 2
HFL Fatty acid
Contains of Fatty acid (g/100 g)
Data From Ref. (7)

| | | | |
|---|---|---|---|
| Myristic acid | 2.2 | Linoleic acid | 32.5 |
| Palmitic acid | 19.7 | Linolenic acid | 3.3 |
| Stearic acid | 2.3 | Saturated fatty acid | 27.4 |
| Palmitoleic acid | 12.7 | Unsaturated fatty acid | 68.2 |
| Oleic acid | 18.2 | Essential fatty acid | 36.0 |

The above table indicate non-saturated fatty acid of HFL powder account for 68.2% of total amount of fatty acid. Thereinto essential fatty acid account for 36% (Mainly Linoleic acid). Plant oil contains much more Linoleic and Linolenic acid with richer nutrition than those of animal. HFL belong to animal kind, but it contains much more essential fatty acid than peanut oil and vegetable seed oil.

TABLE 3
Amino Acids of HFL powder, HFL Protein powder and fishmeal (%)

| Amino Acid | HFL | | | HFL protein | | Fishmeal |
|---|---|---|---|---|---|---|
| Data From Ref. No. | [12] | [8] | [6] | [7] | [8] | [6] |
| Aspartic acid | | 5.4 | 6.18 | 9.58 | 7.60 | 2.85 |
| Threonine* | 2.30 | 2.39 | 2.03 | 4.59 | 3.17 | 1.15 |
| Serine | | 1.83 | 1.58 | 4.03 | 2.57 | 1.34 |
| Glutamic acid | | 8.91 | 8.20 | 15.06 | 10.67 | 5.34 |
| Glycine | | 2.36 | 3.84 | 4.55 | 2.67 | 3.27 |
| Alanine | | 3.64 | 2.49 | 6.10 | 3.21 | 2.28 |
| Cystine* | 0.43 | 0.31 | 0.67 | 1.17 | 0.50 | 0.23 |
| Valine* | 2.76 | 2.87 | 3.23 | 5.05 | 3.71 | 1.58 |
| Methionine* | 1.49 | 1.26 | 1.25 | 2.42 | 2.27 | 0.46 |
| Isoleucine* | 2.34 | 3.10 | 2.54 | 4.21 | 3.98 | 1.09 |
| Leucine* | 3.57 | 3.85 | 4.05 | 6.92 | 5.68 | 2.07 |
| Tyrosine | 4.30 | 3.24 | 3.22 | 6.15 | 5.27 | 1.37 |
| Phenylalanine* | 4.32 | 3.08 | 3.51 | 5.74 | 4.87 | 1.19 |
| Lysine* | 4.30 | 4.45 | 4.30 | 9.32 | 4.97 | 1.64 |
| Arginine | | 2.18 | 3.70 | 5.23 | 3.88 | 2.31 |
| Histidine | | 1.27 | 1.96 | 2.91 | 1.59 | 0.70 |
| Proline | | 2.19 | 4.16 | 4.08 | 2.34 | 2.79 |
| Tryptophan* | 0.78 | | | 1.10 | | |
| E | 27.59 | 24.65 | 24.80 | 46.67 | 34.42 | 10.78 |
| N | | 27.68 | 32.47 | 51.54 | 34.62 | 21.29 |
| E + N | | 52.33 | 57.27 | 98.21 | 69.04 | 32.07 |
| E % | | 47 | 43 | 48 | 49 | 34 |
| E/N | | 0.89 | 0.76 | 0.90 | 0.99 | 0.50 |

*Amino acids essential for human
E: Total amount of essential amino acid, N: Total amount of non-essential amino acid.
E%: Percentage of essential ammino acid, E/N: Ratio of essential amino acid and non-essential amino acid.

TABLE 4
Analysis Result of Several Minerals and Trace Elements
in HFL Powder
Mine and elements (PPM)
Data From Ref. [6]

| | | | |
|---|---|---|---|
| K | 71.72 | Zn | 4.40 |
| Na | 20.00 | Fe | 2.33 |
| Mg | 26.97 | Mn | 1.98 |
| Ca | 34.12 | Cu | 0.29 |
| P | 62.35 | B | 0.19 |

TABLE 5
Analysis Result of Vitamin Content in HFLs
Contains of Vitamin (mg/100 g)
Data From Ref. [7]

| | | | |
|---|---|---|---|
| K | 0.35 | B1 | 12.85 |
| A | 1.17 | B2 | 28.86 |
| D | 1.08 | B6 | 7.83 |
| E | 0.45 | B12 | 188.04 |

Storage of HF Eggs and HFL Food:

1. Cryopreservation of Fly Eggs in Long Duration Mission.

Our invention is to gain nutrient food for the crew by raising HFL in space. Here we propose the brief operation in space by the section of egg to HFL in normal operation. That means only raising HFL stead of fly in the space. Because in space the crew could keep the food production going continuously with raising cycle of eggs to eggs while raising HF takes more room and labor. Therefore there is a need to bring adequate fly eggs from earth for food material storage in long duration mission. Fly eggs become HFLs after being hatched. HFL get mature in 4 days and could be baked to HFL food before becoming pupas and flies. This concerns technology of frozen HFL storage in long duration mission to make HFLs keep their strong reproduction and growth ability.

With 10 more years research, currently Drosophila (Fruit Fly) eggs could be hatched successfully after reserving under liquid nitrogen. Drosophila egg could grow to fly and keep its reproduction ability. Lynch of Cornell University reported, they can reach 75-90% high hatch rate [4].and Mazur, hatch rate can reach 70-80% [5]. Insect eggs can be recovered by storing in liquid nitrogen with unlimited term as long as keeping eggcase in proper permeability before being frozen and controlling warming rate[3]. Therefore we suppose HF can reach high hatching rate as well as Drosophila due to they are all flies.

2. Amount of HF Eggs for Storage in Long Duration Mission

we can bring enough frozen HFL eggs in space. we don't have to raise fly for reproducing the HFL in the space while eggs are small size, light weight and easy storage in freeze. They can maintain their reproduction and growth ability in frozen for several decade or hundred years, just like human semen could live that long in freeze. According to our calculation, for every day, each astronaut need 400 g fresh HFL, which is equivalent to 130 g HFL powder. It contains around 80 g protein(see Table 1)that meets the daily protein need of a adult. There is a need of around 6 gram egg for raising 1.6 kg HFL in 4 days and around 0.5 kg egg for one year. Thus for 5 astronauts in 10 years duration mission, it needs to bring around 25 kg egg from earth. It is an acceptable loading weight in space for food resource in several decade. As we have point above, the food resource(HF egg) only weighs 1/300 of fresh HFL and can be easily processed to the nutrient fresh food in short time (after 4 days).

3. Storage Trait of HFL Food

1) HF eggs have long life by storing in liquid nitrogen (Theoretically HF eggs can be storage with unlimited term and can recover from thaw). In normal situation, the crew only need to storage HF eggs in long mission.

2) There is no need of care in the storage of HF eggs. The frozen HF eggs can be taken and unfrozen easily at any time.

3) HF egg is small size and light weight. Its weight is only 1/300 of the HFL hatched from it after 4 days. 5 kg HF eggs are enough for one crew in 10 years mission.

4) In contingency of losing some HF eggs, the left eggs or HFL can be hatched or raised to become HF. Only small number of HF eggs or HFL can reproduce enough eggs in short time for storage.

5) HFL can be processed to HFL powder and stored easily in freeze in long duration mission.

6) The frozen eggs will be bacteria-free in ultra low temperature.

HFL Raising and Waste Recycling in Space

The feedstuff for HFL in space is very simple, mainly use dejection of crew, inedible part of space crop, such as wheat bran, bean dregs and pieces of crop stalk/leaf as feedstuff. HFL particularly like fresh dejection from human as its feedstuff, this is because the human dejection has rich nutrition, so the dejection of the crew can be recycled as the feedstuff for HFLs, and used circularly to reach the purpose of effectively producing nutrition. Most nutrition from dejection can be back to crew by taking the HFL food. In order to decontaminate the viscera of the HFLs before baking them, feed them with the wheat bran or bean dregs for 3-4 hours, then for 3-4 hours hunger, the decontaminated HFLs are ready for baking and processing to food for the crew. The baked HFLs will be grinded and mix with wheat flour or potato mud, and various dressing, then make the varieties with flavourings. The draff after raising HFL is odorless and can be offer to crop plant as high grade fertilizer.

Therefore dejection of crew and castoff of the crop plant can all be recycled and efficiently produce rich Protein food. This special and efficient production for rich protein food is prior to other raising and planting ways. Raising HFL combining with crop plants could develop such a safe, self-sufficient, self sustaining, regenerative integrated systems to recycle wastes to provide food, air, water and enable human to live and work in space and on other planets—independent of earth-provided logistics—for extended periods. The container volume for raising HFL in space is much smaller than that in earth, this is because in status of microgravity HFL and feedstuff have to close touch in order to keep feeding HFL all the time. As to our design, four containers with volume of 40×40×10 CM³ each for HFL raising. The four containers can produce 2 kg fresh HFL per day. Each container shall be divided three layers with thickness of 6 cm and 2 cm and 1 cm respectively.

The upper layer is 6 cm thickness for HFL raising only. It's full of feedstuff with HF eggs on the surface, the feedstuff consist of crew's dejection (feces and urine) mixing with inedible crop and castoff (such as wheat bran, bean dregs and pieces of the crop stalk etc.) and uneaten food. The middle layer with thickness of 2 cm contains wet wheat bran or bean dregs for decontaminating the viscera of the HFLs before baking. The lower layer with thickness of 1 cm is for making the mature HFL hungry, collecting and cleaning the mature HFL. There are two mesh screen between the three layers. The HFL can be cleaned while it go through the tight screen opening. The HFL can be driven to middle and lower layers by strong light shine on the surface of the layer and stay in the both layers for 3˜4 hours respectively, then can be collected in lower layer after staying there for 3-4 hours. Install aeration pipe in both the upper and middle layers for good aeration and oxygen offer. Stir the feedstuff once every 24 hours.

Before raising, the feedstuff and container should be placed in microwave oven for bactericidal processing. Keep the container in dark with 25-28° C. and 60-80% humidity. It needs only observation, stirring the feedstuff once a day and simple light shining operation for HFL moving and collection.

After raising HFL, All the residue which consist of the water and useful contents can be recycled as high level ferfilizer for space crop plants.

Raising HF in Space.

The fly raising and reproduction could be an standby way for sudden case in long duration mission. Moreover, It's easier to raise HFL than HF in space, so a great deal of breeding space, labor force and expanse for raising fly can be saved. In normal situation there is no need to raise HF in long duration mission because enough HF eggs has been carried on and stored. But in contingency of losing some eggs the crew have to raise HF for reproduction. Therefore technology of raising HF should be reserved. Raising HF in space shall be as following points:

1. Selection of HF Eggs: Introduce HF eggs selected in long-term with greatly increased production ability and growth speed.

2. Raising Density: In space the crew only need to raise small number of fly eggs. We suppose raising 1 gram HF eggs in two containers where raising HFL (place net cover outside of the each lower layers for HF raising). 1 g HF eggs will become 6000 couple HF. Every couple fly could reproduce 600 eggs within 10 days. The total eggs could be 3.6×10⁶ and reproduce 300 g eggs within 10 days.

3. Feedstuff: Feedstuff for HF requires better than that for HFL. HF like to eat HFL paste (smash HFL into Paste, 70% HFL paste+30% wheat bran) and fortunately HFL paste could be easily offered in space.

4. Way of Raising:

HF could fly on the net cover where feedstuff can be daubed so that HF could bite them in microgravity HF could reproduce eggs 3 days after ecdysis from pupa. Each female fly could reproduce 600˜1000 eggs in its reproducing life (around 25 days). Placing a plate in the net cover with feedstuff(in space the best is crew's fresh feces) to allure HF to reproduce eggs. The eggs can be collected for storage. The fly should be killed after its reproduction life.

Process of HFL Powder and HFL Food

1. Steps: Collecting Fresh HFL→Clean→Drying→Grinding→Collecting powder→Package→Storage

2. Drying: Microwave under 80° C.

3. Drying within 6 hours after collecting HFL to prevent fresh HFL from becoming pupa.

4. Make HFL food with HFL powder and crop plants. Adding dressing for nourishing and tasty varieties so that the crew could always enjoy them.

Animal Experiment—Application of HFL as Feedstuff

Due to the rich protein and other nutrition HFL contains, apply HFL as feedstuff offering good animal protein to poultry, livestock and aquatic to achieve large rate of reproduction and survive, it is proved by many countries in the world.

As the intake ratio of hens fed by feedstuffs is about 30%, a great deal of nutrition are left in the dejection. HFL can recycle the nutrition from dejection. Experiment points the dejection from three hens feed HFLs, which can meet the nutrition demand of two hens [12]. Thus only one hen's feedituff can sustain three hens. This is the best proven example for HFLs fed by dejection. The method can not only save feedstuffs, but also assure of good health.

Animal experiment of recycling animal dejection by HFL and raising HFL as animal's feedstuff with good effect could offer gist for our invention.

Safety of Raising HFL, HF and Taking HFL Powder

1. Safety of Raising HFL and HF

Raising HFL and HF in space only involved small number of HFL and HF in close container. So Fly Won't get out of the room. HF eggs, feedstuff, container and net cover are disinfected in advance. Therefore the whole raising process is bacteria-free.

2. Safety of Taking HFL Powder

HFL powder for human is dry processed. This way can sterilize. Reference [7] offer data for monitoring bacteria number of HFL powder and indicate HFL powder meet the safety standard for human.

Reference[6][7][8][12]offer data for analyzing and measuring ingredients of HFL powder and prove HFL powder is rich protein food without any poison.

Recycling animal dejection to HFL and using HFL powder as feedstuff for animal has achieved obviously good effect. HFL as food and medicine is also safe for human.

The Advantages of the Present Invention

1. Recycle fully dejection from the crew and inedible crop plants in space as feedstuff for maggot to produce efficiently nourishing food. Combining with space crop plants, that could achieve a regenerative integrated system with close loops in space.

2. Maggots offer many kinds of nutrition such as rich protein, fat, amino acids, vitamin, minerals, electrolytes and many unknown nutrition, combining with crop can meet the most needs of nutrition in long duration mission.

3. With the storage technology of frozen fly eggs in long-term could achieve safe and sufficient food and food ingredient storage in long duration mission.

4. Maggot has very strong reproduction ability, short cycle and high speed of growth and reproduction. It is easy to raise continuously day and night in high density to achieve the efficient and self-sufficient food production.

5. Maggots never get disease and there is no need of much care to raise them.

6. Raising maggot and producing maggot food don't produce harmful substance to pollute environment. There are no any chemicals for raising maggot and processing food. It is safe and nourishing and has no poison for human body.

7. It is a well developed technology which can be easily transferred to space application with less research investment and time.

8. Raising maggot only needs simple production equipment, operation and technique, food process and storage with little space so that the food cost could be minimized.

9. Experiment prove maggot powder has strong efficacy of adjusting immunity, resisting fatigue and radiation, protecting liver, resisting bacteria, cancer and caducity, improving digestion and appetite etc. Those function are all match the demands of a space food.

What is claimed is:

1. Raising Fly Larvae(maggot) in space as space food for crew.

2. Raising Fly Larvae as defined in claim 1, the crew dejection and inedible crop plants in space be fully recycled as FL feedstuff to produce efficiently nourishing food directly.

3. Raising Fly Larvae as defined in claim 1, FL can be carrier for some special ingredients by raising FL with relevant ingredients that crew need, such as vitamins, minerals, electrolytes and antibiotic etc.

4. Raising Fly Larvae as defined in claim 1, the enough fly eggs brought from earth were frozen in liquid nitrogen as the food source, the FL can be hatched from frozen fly eggs any time.

5. Raising Fly Larvae as defined in claim 1, the fly raising could be a standby way in contingency.

6. Raising Fly Larvae as defined in claim 1, to make HFL food by using HFL powder and crop plants with dressing for nourishing and tasty varieties.

7. Raising Fly Larvae as defined in claim 1, the draff after raising HFL is odorless and can be offer to crop plant as high grade fertilizer, the CO₂ from HFL could supply to crop plants for growth requirement.

8. Raising Fly Larvae as defined in claim 1, for those short duration mission in space, or while in disaster lack of food on the earth, such as in polar adventure, on the sea or in war, raising FL with self-dejection could be a way of self-sufficient food production on the earth.
